(19) United States
(12) Patent Application Publication
(10) Pub. No.: US 2016/0119132 A1
(43) Pub. Date: Apr. 28, 2016

(54) METHOD AND DEVICE FOR GENERATING A HASH VALUE

(71) Applicant: Matthew LEWIS, Reutlingen (DE)

(72) Inventor: Matthew LEWIS, Reutlingen (DE)

(73) Assignee: ROBERT BOSCH GMBH, Stuttgart (DE)

(21) Appl. No.: 14/276,569

(22) Filed: May 13, 2014

(30) Foreign Application Priority Data
May 14, 2013 (DE) 102013208836.1

(51) Int. Cl. H04L 9/06

(52) U.S. Cl. CPC H04L 9/0643

(57) ABSTRACT

A method for generating a hash value as a function of digital input data, including: a) division of the input data into 16 input data blocks each having length 32*m bits, b) initialization of eight working data blocks having specifiable values, each of the eight working data blocks having a length of 32*m bits, c) modification of the input data blocks and of the working data blocks.

### CROSS REFERENCE

The present application claims the benefit under 35 U.S.C. § 119 of German Patent Application No. DE 10 2013 208 836.1 filed on May 14, 2013, which is expressly incorporated herein by reference in its entirety.

### FIELD

The present invention relates to a method for generating a hash value as a function of digital input data. The present invention also relates to a device for generating such a hash value.

### BACKGROUND INFORMATION

Hash functions that supply one or more hash values as output values are used in particular in the area of cryptography, specifically for security-relevant applications such as digital signatures, the storage of passwords, and the integrity testing of data files and the like. A widely used group of cryptographic hash functions is based on the so-called Secure Hash Algorithm Version 2 (SHA-2) Standard, described inter alia in the publication “Federal Information Processing Standards Publication, Secure Hash Standard, FIPS PUB 180-3, 2008” and accessible via the Internet at the address http://csrc.insit.gov/publications/fips/180-3. A corresponding U.S. patent is U.S. Pat. No. 6,829,355 B2.

In general, a cryptographic hash function receives a digital input data stream of arbitrary length and generates therefrom a so-called hash value, i.e., digital output data having a specifiable, in particular fixed, length. The hash value is sometimes also referred to as a digital fingerprint.

A particularly important property of the hash value is that even a slight change in the input data of the hash function causes a very large change in the hash value calculated therefrom.

In addition, cryptographic hash algorithms can have three specific properties:

1. The so-called “preimage resistance,” which means that it has to be proven that for all possible output values of the hash algorithm, given finite realistically available computing power it is impossible to discover the associated input data value.

2. The so-called “second preimage resistance,” which means that given knowledge of a data pair made up of an input data value and the associated output data value (hash value) of a hash function, it is realistically not possible to find a second input data value that results in the same output data value, i.e., hash value.

3. “Collision resistance,” which means that it is realistically not possible to find two input data values that result in the same hash value.

### SUMMARY

An object of the present invention is to improve a method and a device of the type named above in such a way that a simpler, efficient implementation is enabled.

This object may be achieved, for example, with a method including the following steps:
a) division of the input data into 16 input data blocks each having length 32*m bits, where m is a whole number greater than or equal to one, and where an index variable i=0, . . . , 15 designates the ith input data block Mᵢ;
b) initialization of eight working data blocks having specifiable values, each of the eight working data blocks having a length of 32*m bits, and an index variable k=0, . . . , 7 designating the kth working data block Wₖ;
c) modification of the input data blocks and of the working data blocks according to the following rules:
   c1) assignment of the content of input data block M_{i,n} to input data block M_{i-1, n+1} for i=1 through 15, where n is a whole number greater than or equal to zero and represents a processing cycle;
   c2) assignment of the content of working data block W_{k,n} to working data block W_{k+1, n+1} for k=0, k=1, k=2, and for k=4, k=5, k=6;
   c3) assignment of an output value of a first function T to input data block M_{15, n+1};
   c4) assignment of an output value of a second function G to working data block W_{0, n+1};
   c5) assignment of an output value of a third function F to working data block W_{4, n+1},
step c) of the modification being carried out N times, where N>1.

According to an example embodiment of the present invention, it has been recognized that the above-defined rules for modifying the input data blocks and the working data blocks enable a particularly efficient technical implementation of the method for generating the hash value. Particularly advantageously, in this way implementations can be realized that have a much lower requirement for gate equivalents than the conventional implementations, based for example on U.S. Pat. No. 6,829,355 B2.

In addition, in the design of the present invention, it may be particularly advantageous if per working cycle only one input data block has to be modified, and that the functions G, F proposed according to the present invention act only on two working data blocks, namely W_{0, n+1}, W_{4, n+1}.

In a preferred specific embodiment, the steps of division of the input data into 16 input data blocks and of the initialization of eight working data blocks can take place simultaneously. Alternatively, these steps can also be carried out in succession or in overlapping fashion.

In an advantageous specific embodiment, it is provided that
A) in the case where m=1
   the function T is defined as T=M_{0,n}+M_{9,n}+(ROTR¹⁷ (M_{14,n}) XOR ROTR¹⁹ (M_{14,n}) XOR SHR¹⁰ (M_{14,n}))+(ROTR⁷(M_{1,n}) XOR ROTR¹⁸(M_{1,n}) XOR SHR³(M_{1,n})), where ROTR^{y} (x) is a bitwise rotation of the operand x by y bits to the right, where SHR^{y}(x) is a bitwise logical shift of the operand x by y bits to the right, where XOR is an exclusive OR operation,
the function G is defined as G=T0+T1, where T0=M_{0,n}+W_{7,n}+(ROTR⁶ (W_{4,n}) XOR ROTR¹¹ (W_{4,n}) XOR ROTR²⁵ (W_{4,n}))+((W_{4,n} AND W_{5,n}) XOR (NOT (W_{4,n}) AND W_{6,n}))+Kₙ, where T1=(ROTR² (W_{0,n}) XOR ROTR¹³ (W_{0,n}) XOR ROTR²² (W_{0,n}))+((W_{0,n} AND W_{1,n}) XOR (W_{0,n} AND W_{2,n}) XOR (W_{1,n} AND W_{2,n})), where AND is an AND operation, NOT being bitwise negation, Wₖ,ₙ being the kth working data block of the processing cycle n, Kₙ being a specifiable constant, where
the function F is defined as F=W_{3,n}+T0.

Particularly preferably, the functions ROTR^{y} (x), SHR^{y} (x) are defined in the same way as in “Federal Information Processing Standards Publication, Secure Hash Standard, FIPS PUB 180-3, 2008.”

In another advantageous specific embodiment, it is provided that

B) in the case where m=2
the function T is defined as T=M_{0,n}+M_{9,n}+(ROTR¹⁹ (M_{14,n}) XOR ROTR⁶¹(M_{14,n}) XOR SHR⁶ (M_{14,n}))+(ROTR¹(M_{1,n}) XOR ROTR⁸(M_{1,n}) XOR SHR⁷(M_{1,n})),
the function G is defined as G=T0+T1, where T0=M_{0,n}+W_{7,n}+(ROTR¹⁴(W_{4,n}) XOR ROTR¹⁸(W_{4,n}) XOR ROTR⁴¹(W_{4,n}))+((W_{4,n} AND W_{5,n}) XOR (NOT(W_{4,n}) AND W_{6,n}))+Kₙ, where T1=(ROTR²⁸(W_{0,n}) XOR ROTR³⁴ (W_{0,n}) XOR ROTR³⁹ (W_{0,n}))+((W_{0,n} AND W_{1,n}) XOR (W_{0,n} AND W_{2,n}) XOR (W_{1,n} AND W_{2,n})), where
the function F is defined as F=W_{3,n}+T0.

In variant A) of the above-named specific embodiment, the input data from which the hash value is generated are thus divided into 16 input data blocks each having a length of 32 bits. Variant A) of the present specific embodiment represents a starting point for indicating a method for generating a hash value that is compatible with the SHA-2 standard of type SHA 256, as shown below.

Variant B) of the above-named specific embodiment is a variant of the present invention representing a basis for hash value formation according to the SHA-2 standard type SHA512.

With regard to the shift and rotation operations on the various input data blocks and working data blocks, reference is further made to the FIPS standard identified above. The corresponding functions are defined there in detail, and are preferably used in the same way in the present context.

In a further preferred specific embodiment, eight hash data blocks are provided, each of the eight hash data blocks having a length of 32*m bits, and where after execution (r*N) times of step c) according to patent claim 1, the content of the working data blocks is added, preferably blockwise, to the content of the hash data blocks, where r is a whole number greater than or equal to 1. In this way, after each execution of step c), i.e., the modification of the input data blocks and of the working data blocks according to the rules proposed according to the present invention, a hash value is iteratively formed that is stored in the hash data blocks. In a preferred specific embodiment, N=64 and m=1, so that each hash data block has a length of 32 bits.

As long as a length of the input data from which the hash value is to be formed does not exceed for example 512 bits, according to a specific embodiment it is adequate to write the input data completely to the input data blocks and to carry out the method according to the present invention. After the execution N times of step c) of modification, data are then already present in the working data blocks that can be used as the hash value.

For the case in which the hash value is to be formed using the design of the present invention from input data longer than 512 bits, after the step c) of modification has been executed N times it is however possible, as proposed above, to first copy the content of the working data blocks to the hash data blocks, or add it thereto, and to subsequently carry out at least one further execution N times of step c) of the method, so that a hash value is formed, or accumulated, iteratively in the hash data blocks that is a function of the total input data (greater than 512 bits).

According to a further advantageous specific embodiment, the step of addition of the content of the working data blocks to the content of the hash data blocks advantageously has the following steps: assignment of a sum of first data block W_{7,n} and hash data block H_{7,n} to hash data block H_{0, n+1}. In other words, the content of working data block W₇ of the current clock cycle n and the content of hash data block H₇ of the current working or clock cycle n are used as input quantities for the adder, and the sum thereof is assigned to hash data block H₀ for the following working cycle n+1. In addition, a respective value of hash data block H_{I-1} of the current clock cycle n is assigned to hash data block H_{I} of the following clock cycle n+1, for I=1 through 7.

In a further advantageous specific embodiment, it is provided that m=1 and/or N=64 and/or in the step of initialization of the eight working data blocks the following assignment takes place: W_{0,0}=0×6a09e667, W_{1,0}=0×bb67ae85, W_{2,0}=0×3c6ef372, W_{3,0}=0×a54ff53a, W_{4,0}=0×510e527f, W_{5,0}=0×9b05688c, W_{6,0}=0×1f83d9ab, W_{7,0}=0×5be0cd19, and/or the eight hash data blocks are initialized using the following assignment: H_{0,0}=0×6a09e667, H_{1,0}=0×bb67ae85, H_{2,0}=0×3c6ef372, H_{3,0}=0×a54ff53a, H_{4,0}=0×510e527f, H_{5,0}=0×9b05688c, H_{6,0}=0×1f83d9ab, H_{7,0}=0×5be0cd19. In this specific embodiment, the method according to the present invention corresponds to the SHA-2 method of the type SHA 256 with regard to the result of the hash value. Thus, despite a calculation method deviating significantly from the existing art, the same hash values are obtained as in SHA 256.

Particularly advantageously, this variant of the present invention accordingly enables complete compatibility with the standardized FHA 256 method, although at the same time a significantly more efficient implementation is advantageously possible than in the known devices. In a further advantageous specific embodiment, it is provided that m=2 and/or N=80 and/or in the step of initialization of the eight working data blocks the following assignment takes place: W_{0,0}=0×6a09e667f3bcc908, W_{1,0}=0×bb67ae8584caa73b, W_{2,0}=0×3c6ef372fe94f82b, W_{2,0}=0×a54ff53a5f1d36f1, W_{4,0}=0×510e527fade682d1, W_{5,0}=0×9b05688c2b3e6c1f, W_{6,0}=0×1f83d9abfb41bd6b, W_{7,0}=0×5be0cd19137e2179, and/or the eight hash data blocks are initialized using the following assignment: H_{0,0}=0×6a09e667f3bcc908, H_{1,0}=0×bb67ae8584caa73b, H_{2,0}=0×3c6ef372fe94f82b, H_{3,0}=0×a54ff53a5f1d36f1, H_{4,0}=0×510e527fade682d1, H_{5,0}=0×9b05688c2b3e6c1f, H_{6,0}=0×1f83d9abfb41bd6b, H_{7,0}=0×5be0cd19137e2179.

In this variant of the present invention, a compatibility with the SHA 512 standard is advantageously provided, and again a particularly efficient implementation is enabled that requires a lower number of gate equivalents than the conventional systems.

In further specific embodiments, compatibility can also be produced to the existing standards SHA224 and SHA384. For this purpose, instead of the above-mentioned initialization values for the working data blocks and/or the hash data blocks in SHA256 or SHA512, the values from chapters 5.3.2 (SHA224) or 5.3.4 (SHA384) of the document “FIPS PUB 180-4 FEDERAL INFORMATION PROCESSING STANDARDS PUBLICATION Secure Hash Standard (SHS) CATEGORY: COMPUTER SECURITY SUBCATEGORY: CRYPTOGRAPHY Information Technology Laboratory National Institute of Standards and Technology, Gaithersburg, Md. 20899-8900, March 2012” are to be used, where the parameter m=1 is to be chosen for SHA224 and m=2 is to be chosen for SHA384.

In addition, in a specific embodiment for SHA224 compatibility it can be provided to use only seven of the eight hash data blocks as output hash value (7*32 bits (m=1) yields 224 bits).

In addition, in a specific embodiment for SHA384 compatibility it can be provided to use only six of the eight hash data blocks as output hash value (6*64 bits (m=2) yields 384 bits).

In a further advantageous specific embodiment, it is provided that a first shift register is used for the at least temporary storage of the input data blocks. Alternatively or as a supplement, a second shift register can be used for the at least temporary storage of the working data blocks. Further alternatively or as a supplement, advantageously a third shift register can be used for the at least temporary storage of the hash data blocks.

The use of one or more shift registers for storing the corresponding data blocks is particularly advantageous because the method according to the present invention having the functions T, G, and F can be implemented very efficiently using shift registers. In particular, in this way it is also possible to omit numerous multiplexers or address decoders etc., as are required in conventional implementations, again significantly reducing the complexity and thus also the costs of a corresponding implementation in circuitry of the present invention.

In a further advantageous specific embodiment, it is provided that the step of assignment of the content of input data block M_{i,n} to input data block M_{i=1,n+1} for i=1 through 15 has a preferably blockwise shifting of the content of input data block M_{i,n} to the first shift register, and/or the step of assignment of the content of working data block W_{k,n} to working data block W_{k+1,n+1} for k=0, k=1, k=2 and for k=4, k=5, k=6 has a preferably blockwise shifting of the content of working data block W_{k,n} to the second shift register, and/or the step of assignment of the value of hash data block H_{I-1,n} to hash data block H_{I,n+1} for I=1 through 7 has a preferably blockwise shifting of the content of hash data block H_{I-1,n} to the third shift register.

Particularly advantageously, in a further specific embodiment it is provided that in a first operating phase the first shift register and the second shift register are clocked together for N clock cycles in order to control the preferably blockwise shifting of the content of the first shift register and the preferably blockwise shifting of the content of the second shift register.

During this first operating phase, if a third shift register is provided for the storage of the hash data block this third shift register does not already have to be clocked. In a second operating phase that preferably directly follows the first operating phase, it is provided that the second shift register and the third shift register are clocked together for 8 clock cycles, no clocking of the first shift register preferably taking place during the second operating phase.

In this way, a particularly efficient and energy-saving operation is enabled of the shift registers that can be used according to the present invention.

In a further advantageous specific embodiment, it is provided that
i. In order to determine the expressions ROTR¹⁷ (M_{14,n}) of the first function T the following steps are executed:
   e1) determination of the expression V1=ROTR¹⁷ (M_{14,n}),
   e2) determination of the expression V2=ROTR² (V1), in order to obtain ROTR¹⁹(M_{14,n}),
      and/or
ii. in order to determine the expressions ROTR⁷(M_{1,n}), ROTR¹⁸(M_{1,n}) of the first function T, the following steps are executed:
   f1 determination of the expression V3=ROTR⁷ (M_{1,n}),
   f2) determination of the expression V4=ROTR¹¹ (V3), in order to obtain ROTR¹⁸ (M_{1,n}),
      and/or
iii. in order to determine the expressions ROTR² (W_{0,n}), ROTR¹³ (W_{0,n}), ROTR²² (W_{0,n}) of the second function G, the following steps are executed:
   g1) determination of the expression V5=ROTR²(W_{0,n}),
   g2) determination of the expression V6=ROTR¹¹ (V5), in order to obtain ROTR¹³ (W_{0,n}),
   g3) determination of the expression V7=ROTR⁹ (V6), in order to obtain ROTR²² (W_{0,n}).

The above calculating enable a particularly efficient determination of the corresponding terms for evaluating the functions proposed according to the present invention, and avoid unnecessary multiple calculations of the same expressions.

### BRIEF DESCRIPTION OF THE DRAWINGS

Below, exemplary specific embodiments of the present invention are explained with reference to the figures.

FIG. 1 schematically shows a block diagram illustrating the use of hash values.

FIG. 2a schematically shows a simplified flow diagram of a specific embodiment.

FIG. 2b schematically shows a flow diagram according to a further specific embodiment.

FIG. 2c schematically shows a flow diagram according to a further specific embodiment.

FIG. 3 schematically shows a block diagram of a device according to a specific environment.

FIG. 4 schematically shows input data blocks and working data blocks according to a specific embodiment.

FIG. 5a,b,c schematically each show input data blocks and working data blocks according to a specific embodiment, in different clock or working cycles.

FIG. 6 schematically shows a block diagram of a further specific embodiment of a device according to the present invention.

FIG. 7 schematically shows a time diagram illustrating different operating phases according to a specific embodiment.

### DETAILED DESCRIPTION OF EXAMPLE EMBODIMENTS

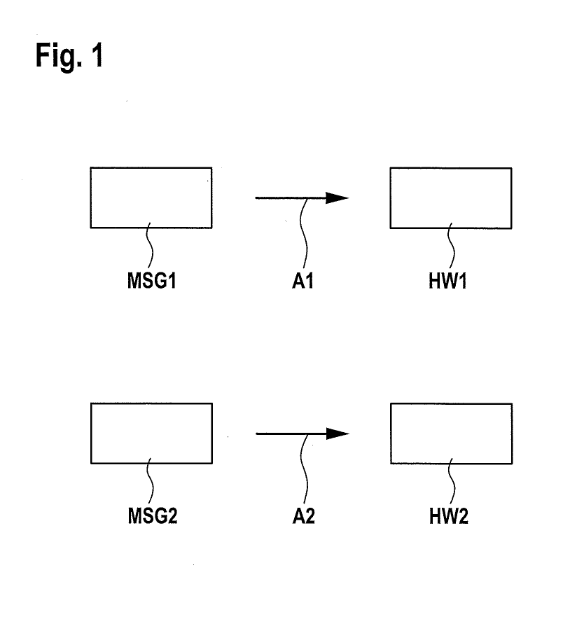

FIG. 1 schematically shows a scenario in which, as a function of a first message MSG1, a first hash value HW1 is formed using a hash algorithm. This first message MSG1 can be digital data of arbitrary length, present for example as a bit sequence (bit string). The formation of the hash value is illustrated symbolically in FIG. 1 by arrow A1.

A further hash value formation, this time using second input data MSG2 which are different from first input data MSG1, but using the same hash algorithm, is designated by arrow A2 in FIG. 1. As a result, a second hash value HW2 is obtained. Typically, hash value HW2 deviates significantly from hash value HW1, to the extent that input data MSG1, MSG2 differ from one another, in particular if input data MSG1, MSG2 differ from one another only slightly, e.g., in one bit position. In other words, a Hamming distance between different input data MSG1, MSG2 is standardly carried over into a significantly enlarged Hamming distance of the corresponding hash values HW1, HW2 by a hash value formation A1, A2.

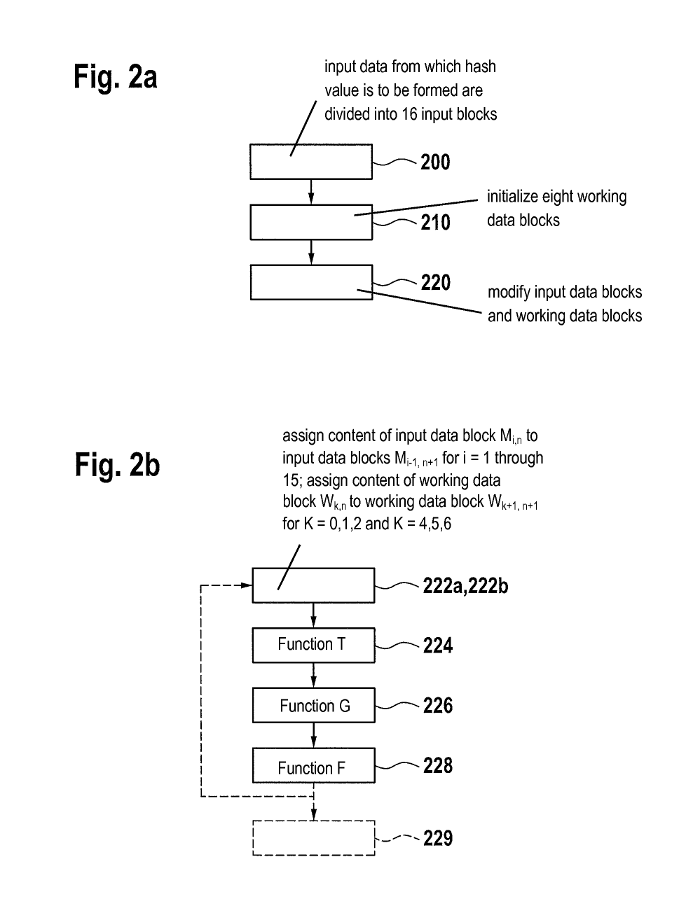

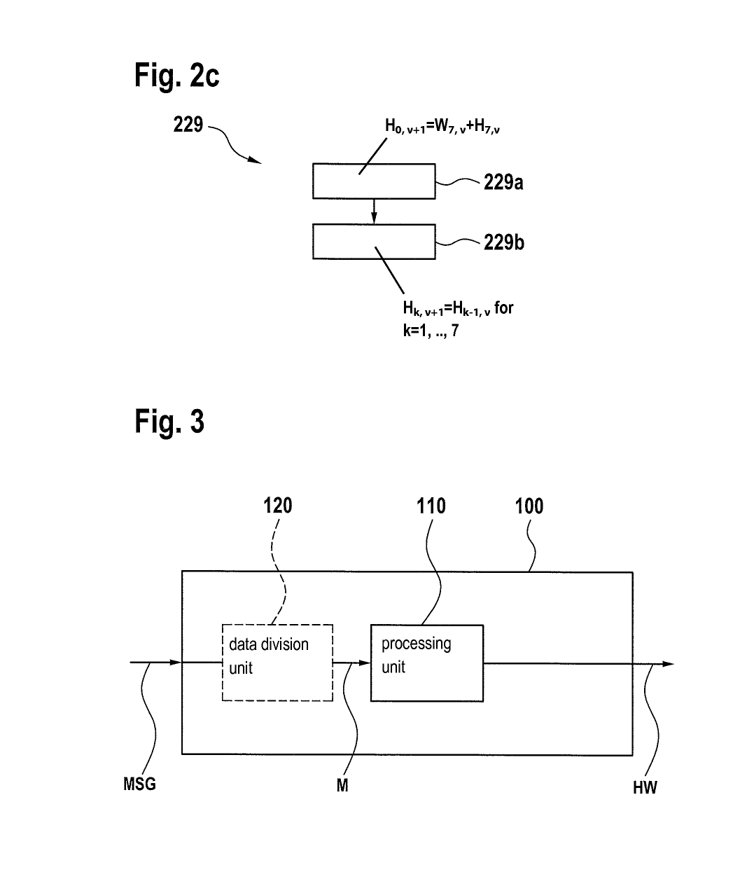

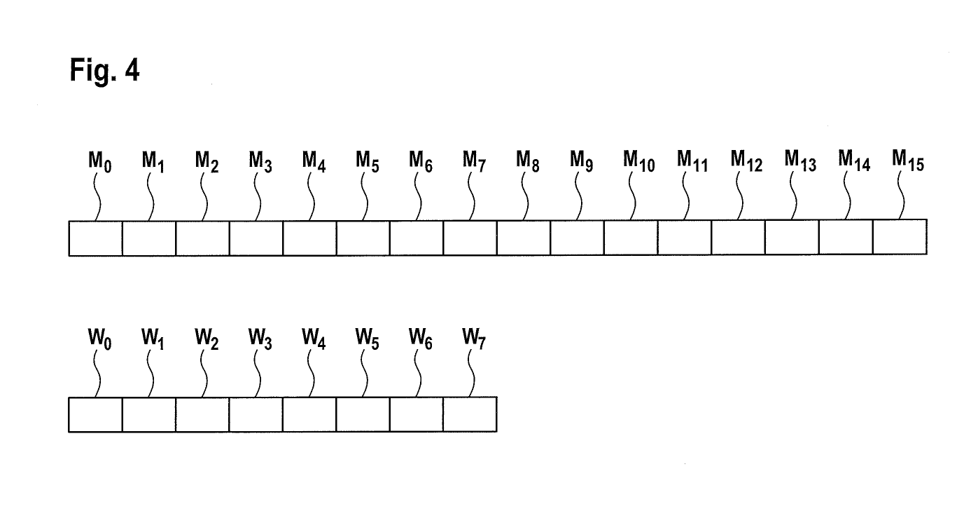

FIG. 2a shows a simplified flow diagram of a first specific embodiment of the method according to the present invention for generating a hash value. In a first step 200, input data from which the hash value is to be formed are divided into 16 input data blocks each having length 32*m bits, where m is a whole number greater than or equal to 1. In a particularly preferred specific embodiment, m=1, so that the 16 input data blocks correspond to 16 32-bit data words. Other values, for example m=2 etc., are also possible.

In a following step 210, cf. FIG. 2a, eight working data blocks are initialized with specifiable values. Analogous to the input data blocks, the eight working data blocks also each have a length of 32*m bits, in the present case thus 32 bits in each case.

In a preferred specific embodiment, the steps of division 200 of the input data and of the initialization 210 of eight working data blocks can also take place simultaneously. Alternatively, these steps can also take place in succession or in overlapping fashion.

In a following step 220, the input data blocks, or at least one of the input data blocks, and the working data blocks, or at least one of the working data blocks, are modified according to the rules described in detail below, in order to generate a hash value.

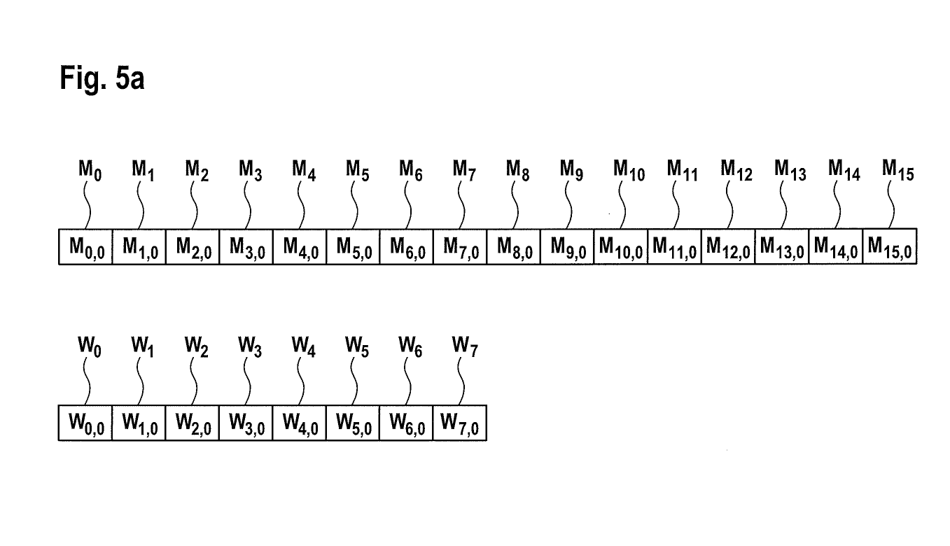

For this purpose, FIG. 3 shows a block switching diagram of a specific embodiment of a device 100 according to the present invention.

Device 100 has at the input side a message MSG, and as a function of this message MSG forms a hash value HW, using the method according to the present invention, and outputs it at its output. The hash value formation takes place for example in processing unit 110, which is fashioned for the execution of the method according to the present invention.

Optionally, device 100 can also have a data division unit 120, indicated by a dashed rectangle, which conditions message MSG before this message is supplied to device 110 in the form of digital input data M.

For example, according to a specific embodiment of the present invention in which the parameter m is selected to be m=1, the above-described 16 input data blocks can overall accommodate 512 bits of data. If the message MSG from which hash value HW is to be formed has exactly 512 bits, then message MSG can be supplied directly as digital input data M to device 110 for the hash value formation.

If message MSG has a length less than 512 bits, it is for example possible to adapt the length of message MSG to the reference length of 512 bits by filling bit locations in a predefined manner, in particular using padding. The padding can for example include the annexing of pre-determinable bit sequences at the beginning or at the end of message MSG. In this case, thus, input data M are obtained, using padding, from message MSG, where the padding can be carried out for example by unit 120.

If message MSG has a length greater than 512 bits, the method of the present invention is also applicable; in this case, preferably first a decomposition of message MSG takes place into blocks each having 512 bits plus, if warranted, a remaining data block having a length less than 512 bits, gradually supplied to device 110 for hash value formation.

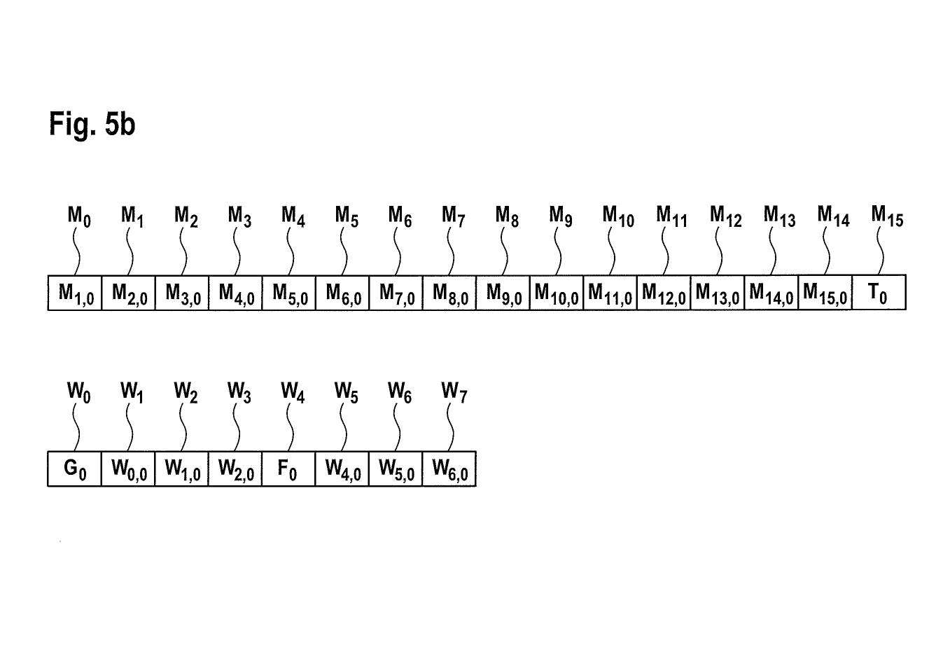

FIG. 4 shows as an example the 16 input data blocks M₀, M₁, . . . , M₁₅ according to a specific embodiment. In the variant of the invention having the parameter m=1, each input data block M₀, M₁, . . . , M₁₅ has a size of 32 bits. All input data blocks M₀, M₁, . . . , M₁₅ together thus yield 512 bits, as described above. In contrast, in a different specific embodiment of the present invention having the parameter m=2, each input data block M₀, M₁, . . . , M₁₅ has a size of 64 bits, so that all input data blocks M₀, M₁, . . . , M₁₅ together yield 1024 bits. FIG. 4 schematically shows eight working data blocks W₀ through W₇ as are usable for the execution of the method according to the present invention. If input data blocks M₀, M₁, . . . , M₁₅ have a bit length of 32 bits, this preferably also holds for working data blocks W₀ through W₇.

For the following description, it is assumed that message MSG (FIG. 3 forming the basis for the hash value formation has a length of exactly 512 bits. In this case, message MSG is written directly, as digital input data M, into input data blocks M₀ through M₁₅ according to FIG. 4, thus initializing these input data blocks.

Working data blocks W₀ through W₇ can also be initialized using pre-determinable values. In a further specific embodiment, however, this is not required; that is, the initialization can take place using the null value or random values or the like.

However, particularly preferably, for the initialization of working blocks W₀ through W₇ in a further specific embodiment the following values are used for the initialization:

W_{0,0}=0×6a09e667, W_{1,0}=0×bb67ae85, W_{2,0}=0×3c6ef372, W_{3,0}=0×a54ff53a, W_{4,0}=0×510e527f, W_{5,0}=0×9b05688c, W_{6,0}=0×1f83d9ab, W_{7,0}=0×5be0cd19.

In the present notation, the prefix “0×” means that these are initialization values for the working data blocks by hexadecimal numbers. The first index indicates which of the eight working data blocks is concerned, and the second index indicates a working cycle for the execution of the hash value formation. For example, thus working data block W₀ is initialized for the 0^{th} working cycle (n=0) with the hexadecimal number 6a09E667 (W_{0,0}=0×6a09e667), and so forth.

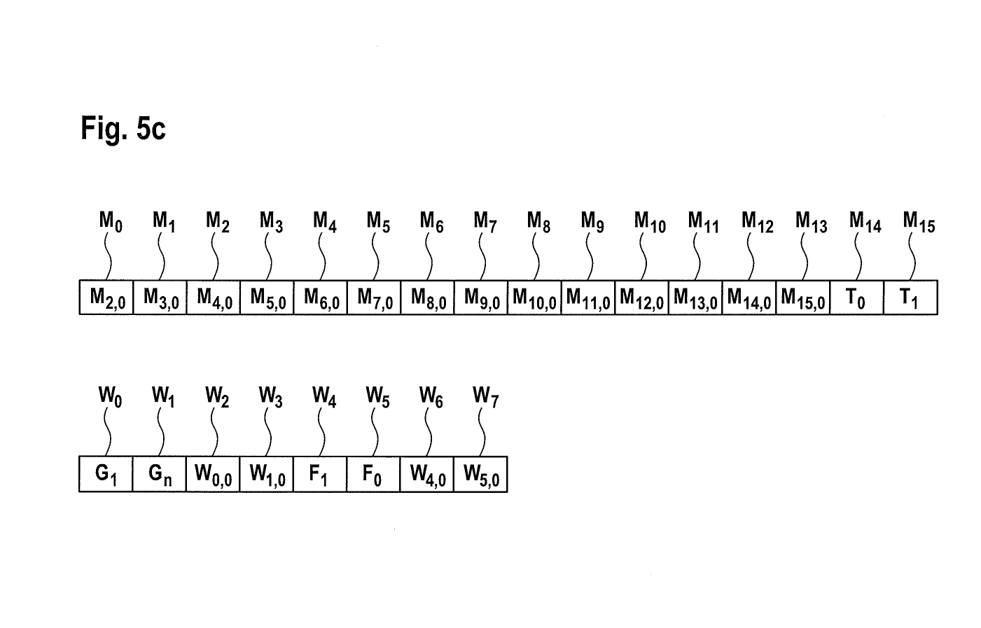

After the initialization, there results the state shown schematically in FIG. 5a, corresponding to working cycle n=0. Input data blocks M₀ through M₁₅ have their initialization values M_{0,0} through M_{15,0}, which correspond directly to the 512 bits, grouped to form 16 blocks of 32 bits each, corresponding to the input data blocks.

Working data blocks W₀ through W₇ are for example initialized with their initialization values W_{0,0} through W_{7,0} according to the statements made above.

After the initialization, which corresponds to the zeroth working or clock cycle, i.e. n=0 (cf. FIG. 5a), the example method according to the present invention is carried out. A variant of the method is described in the following with reference to FIG. 2b. In a first step 222a, the content of input data block M_{1,n} is assigned to input data block M_{i-1, n+1} for i=1 through 15. This means that the 15 input data blocks M₀ through M₁₄ each receive, in the following working cycle n=1, the content of input data block M₁ through M₁₅ from the current working cycle n=0 as value assignment. This state is shown schematically in FIG. 5b. For example, input data block M₀ now contains, i.e. in cycle n=1, as content the value M_{1,0}, which corresponds to the content of working data block M₁ from the preceding working cycle n=0, and so on.

Step 222a (FIG. 2b) of assignment according to the present invention thus corresponds to a shifting of the contents of the 15 input data blocks M_{1,0} through M_{15,0} from the first cycle n=0, which, in a technical implementation of the present invention, can be realized particularly advantageously using shift registers. For example, a first shift register is used for the at least temporary storage of input data blocks M₀ through M₁₅, the shift register having a total of 16 blocks each having 32 bits. The shift operation according to the present invention, which is the subject matter of step 222a of FIG. 2b, can advantageously be brought about for example by a block-by-block shifting of the relevant input data blocks.

In a further step 222b (FIG. 2b), which preferably can also be carried out simultaneously with step 222a, the content of working data block W_{k,n} is assigned to working data block W_{k+1, n+1} for k=0, 1,2 and for k=4,5,6. In other words, starting from the initialization state at working cycle n=0 (FIG. 5a), the content of working data blocks W₀, W₁, W₂ is thus assigned to working data blocks W₁, W₂, W₃ of the following working cycle n=1 (FIG. 5b). A comparable shift also results for the contents of working data blocks W₄, W₅, W₆.

If a second shift register is used for the at least temporary storage of working data blocks Wₖ, then the shift operation corresponding to method step 222b according to the present invention can preferably be carried out simultaneously or synchronously with the shift operation according to step 222a, so that the same control signals can be used for the relevant shift registers.

As can be seen from a comparison of input data blocks M₀ through M₁₅ and working data blocks W₀ through W₇ at the first working cycle n=0 with input data blocks M₀ through M₁₅ and working data blocks W₀ through W₇ according to the following working cycle n=1 (FIG. 5b), the predominant number of working data blocks, or input data blocks, or the content thereof, i.e. in the present case the respective 32-bit values, have merely been shifted within working data blocks W or input data blocks M in the context of steps 222a, 222b (FIG. 2b) according to the present invention.

This can be implemented particularly efficiently using shift registers.

Only input data block M₁₅, and working data blocks W₀, W₄, obtain their new (present at working cycle n=1) content not through a shift operation but rather through the evaluation of functions T, G, F provided according to the present invention.

Accordingly, input data block M₁₅ according to FIG. 5b is assigned the initial value of function T for working cycle n=0, i.e. M_{15,1}=T₀, and working data blocks W₀, W₄, . . . are assigned the corresponding output values of functions G, F, in each case in turn evaluated at the first working cycle n=0, i.e. W_{0,1}=G₀ and W_{4,1}=F₀, in order to obtain the corresponding values of data blocks M₁₅, W₀, W₄ for working cycle n=1 (FIG. 5b).

The assignment of the function values of function T, G, F to the corresponding data blocks takes place, in the flow diagram according to FIG. 2b, in steps 224 (function T), 226 (function G), and 228 (function F). Two or more of these steps can preferably also be carried out in parallel, thereby correspondingly shortening the overall processing time for generating hash value HW (FIG. 3).

Particularly preferably, in a specific embodiment the method sequence described above with reference to FIG. 2b and steps 222a through 228 is carried out N times, where N is greater than 1, thus ensuring that hash values HW obtained according to the present invention satisfy the cryptographic security requirements for hash values.

In a further advantageous specific embodiment, in particular after execution N times of steps 222a through 228 according to FIG. 2b the values W_{0,N-1} through W_{7,N-1} then present in working data blocks W₀ through W₇ can be shifted into hash data blocks H₀ through H₇ that may be present (for m=1, each of the eight hash data blocks H₀ through H₇ also correspondingly has 32-bit data length), or added to the values contained therein; cf. step 229 from FIG. 2b. This is for example useful when, in a first execution N times of steps 222a through 228 according to FIG. 2b, a first block, having 512 bits, of input data M is processed, and when, in at least one further execution N times of steps 222a through 228 according to FIG. 2b, a second block having 512 bits of input data M is processed, which for example makes sense when the message MSG (FIG. 3) forming the basis for the hash value formation has 1024 bits. In this way, iterative hash values can thus be obtained in hash data blocks H₀ through H₇ that are a function of a plurality of blocks of input data M. If message MSG forming the basis for the hash value formation has a length of 512 bits or less, it is also possible to take the hash value HW directly from working data blocks W₀ through W₇. In this case, no hash data blocks are thus required.

FIG. 5c shows the content of input data blocks M₀ through M₁₅ and of working data blocks W₀ through W₇ at the end of working cycle n=2. A comparison of FIG. 5b and FIG. 5c shows that, again, a large part of the contents of the input data blocks or of the working data blocks has been shifted relative to the preceding working cycle n=1 (FIG. 5b). For example, content T₀ of input data block M₁₅ of FIG. 5b has been assigned to input data block M₁₄ from FIG. 5c. A comparable situation holds for the content of working data blocks W₅, W₁ according to FIG. 5c.

The new evaluation of function T according to the present invention, this time based on input values of working cycle n=1, has resulted in the assignment of a corresponding functional value T₁ only to input data block M₁₅, i.e. M_{15, 2}=T₁. The same holds for working data blocks W₀, W₄, to which the new function values G₁, F₁ have been assigned, i.e. W_{0,2} =G₁ and W_{4, 2}=F₁.

In a particularly preferred specific embodiment, the method sequence according to the present invention of steps 222a through 228 is repeated N=64 times, as indicated by the dashed arrow from step 228 to step 222a in FIG. 2b. Here there results a particularly good hash value that at the end of the method sequence described according to the present invention is contained in working data blocks W₀ through W₇, or in the corresponding shift register. The hash value can be used directly as output value HW of device 100 according to the present invention (FIG. 3).

In a particularly preferred specific embodiment, for which m=1 is selected, there results the following for the definition of functions T, G, F according to the present invention:

T=M_{0,n}+M_{9,n}+(ROTR¹⁷ (M_{14,n}) XOR ROTR¹⁹ (M_{14,n}) XOR SHR¹⁰ (M_{14,n}))+(ROTR⁷ (M_{1,n}) XOR ROTR¹⁸ (M_{1,n}) XOR SHR³ (M_{1,n})), [Equation 1],

where ROTR^{y} (x) is a bitwise rotation of operand x by y bits to the right, where SHR^{y}(x) is a bitwise logical shift of operand x by y bits to the right, where XOR is an exclusive OR operation;

G=T0+T1 [Equation 2],

where

T0=M_{0,n}+W_{7,n}+(ROTR⁶(W_{4,n}) XOR ROTR¹¹(W_{4,n}) XOR ROTR²⁵(W_{4,n})+((W_{4,n} AND W_{5,n}) XOR (NOT(W_{4,n}) AND W_{6,n}))+Kₙ, [Equation 3],

where T1=(ROTR²(W_{0,n}) XOR ROTR¹³(W_{0,n}) XOR ROTR²²(W_{0,n}))+((W_{0,n} AND W_{1,n}) XOR (W_{0,n} AND W_{2,n}) XOR (W_{1,n} AND W_{2,n})), [Equation 4],

where AND is a bitwise AND operation, NOT is a bitwise negation, W_{k,n} is the kth working data block of processing cycle n, Kₙ is a specifiable constant (preferably, for different working cycles n, in each case a different value is indicated for constant Kn); the function F is defined as:

F=W_{3,n}+T0 [Equation 5].

It is to be noted that values T0, T1 according to Equation 3 and Equation 4 are auxiliary quantities for the calculation of functions G, F, and that in particular auxiliary quantity T0 according to Equation 3 is not to be confused with quantity Tₙ₌₀, abbreviated T₀, which quantity T₀ represents the initial value of the function T (Equation 1) at working cycle n=0.

Thus, in order for example to determine an output value T₀ of function T for working cycle n=0 (initialization state), as input quantities the contents of input data blocks M_{0,0}, M_{9,0}, M_{14,0}, M_{1,0} are supplied to the function T as input quantities, and are subjected to corresponding shift or rotation operations. Output value T₀ of function T for working cycle n=0 results as the sum of the individual expressions according to the above definition. According to the present invention, this value is assigned to input data block M₁₅ of the next following working cycle (here: n=1; cf. FIG. 5b), i.e., M_{15,1}=T₀. An analogous procedure is used to determine the values of functions F, G.

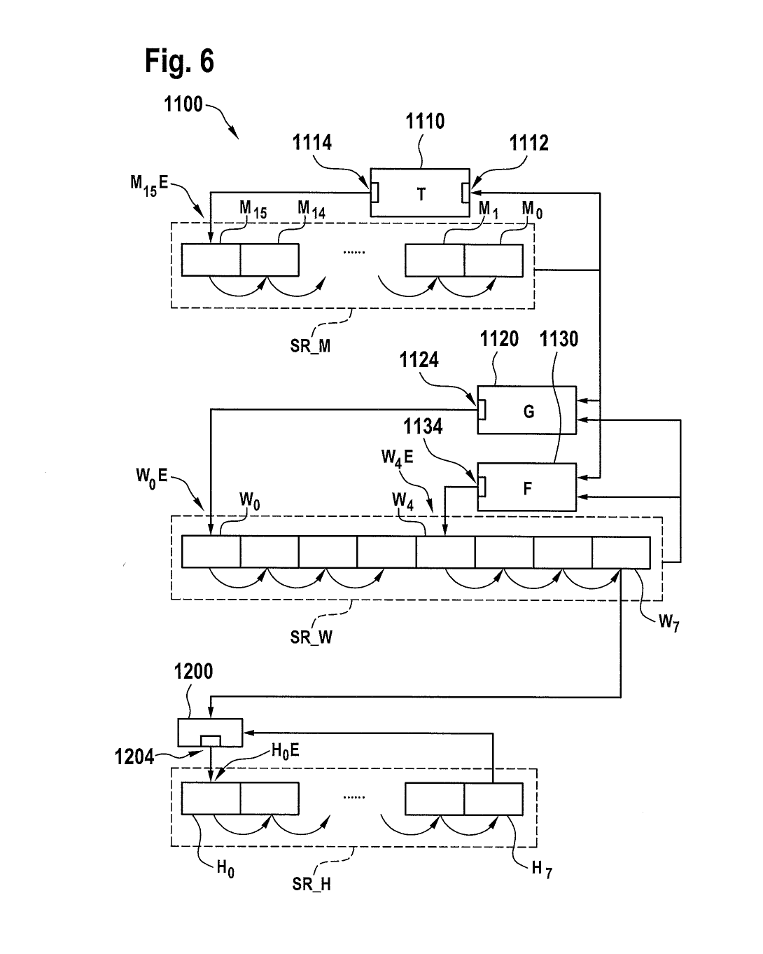

FIG. 6 schematically shows a block diagram of a further specific embodiment of device 1100 according to the present invention, which enables a particularly efficient implementation, e.g., as an integrated circuit. The described specific embodiment enables a rapid and at the same time energy-efficient hash value formation, and requires for its realization only a particularly low number of gate equivalents (GE). Nonetheless, complete compatibility with the SHA-2 standard, e.g. type SHA 256, can advantageously be achieved.

For the at least temporary storage of the 16 input data blocks M₀ through M₁₅, in device 1100 according to FIG. 6 a first shift register SR_M is provided that correspondingly has 16 blocks each having 32 bit storage width (in the present case, m=1 is selected). First shift register SR_M advantageously enables, with corresponding controlling with a control signal not shown in FIG. 6, a block-by-block shifting of the contents of input data blocks M₀ through M₁₅ in blocks each having 32 bits, i.e.

the unit of a corresponding input data block. This means that after a shift operation for example the content of block M₁₅ has been shifted into block M₁₄. This is indicated in FIG. 6 by the curved arrows, not shown in more detail, in the lower region of shift register SR_M, which point from a particular data block of shift register SR_M to a data block of shift register SR_M that is in each case adjacent at the right.

A second shift register SR_W is provided for the at least temporary storage of working data blocks W₀ through W₇. Second shift register SR_W correspondingly has a total of eight data blocks each having a bit width of 32 bits (in the present case, m=1 is selected). A shift operation takes place for second shift register SR_W in a manner corresponding to first shift register SR_M, i.e., using corresponding controlling by a control signal not shown in FIG. 6.

In addition, FIG. 6 shows a third shift register SR_H provided for the at least temporary storage of hash data blocks H₀ through H₇. Third shift register SR_H correspondingly also has eight data blocks each having a bit width of 32 bits (in the present case, m=1 is selected), and is therefore—with regard to the eight data blocks each having 32 bits—generally identical in design to second shift register SR_W.

The control signals for the above-described shift registers can be generated by a control unit (not shown) of device 1100, realized for example in the form of a state machine or also by an ASIC and/or FPGA or the like.

Device 1100 further has a first function block 1110 that is provided for the execution of first function T. For this purpose, first function block 1110 has an input 1112 via which the relevant input data can be supplied to first function block 1110. In the case in which parameter m=1 is selected, these are for example the contents of input data blocks M₀, M₁, M₉, M₁₄. The supplying of the corresponding input data to input 1112 of function block 1110 is symbolized in FIG. 6 by the arrow pointing to input 1112. Given an implementation in circuitry, the supplying of the corresponding input data to first function block 1110 can for example be realized in that first shift register SR_M has parallel outputs that are assigned to input data blocks M₀, M₁, M₉, M₁₄, so that the contents of these input data blocks can be supplied to input 1112 of first function block 1110. For this purpose, preferably a fixed wiring can be used from input data blocks M₀, M₁, M₉, M₁₄ to component 1112, this wiring having a very low complexity of circuitry in comparison with an addressing logic using a multiplexer, as is required in conventional SHA-2 implementations.

First function block 1110 correspondingly evaluates first function T and outputs, at its output 1114, a corresponding function value that is supplied to shift register SR_M, specifically to the data block that corresponds to input data block M₁₅. In this way, the above-described step c3) of the assignment of an output value of first function T to input data block M₁₅ is realized. For this purpose, output 1114 of first function unit 1110 is preferably connected directly to a preferably parallel input M₁₅E of input data block M₁₅. In terms of circuitry, this can be realized for example by a 32-bit parallel data bus from output 1114 of first function unit 1110 to input M₁₅E of input data block M₁₅.

In a comparable manner, the input data (input data blocks M₀, M₁, M₉, M₁₄) can be supplied via parallel data buses from first shift register SR_M to input 1112 of first function unit 1110.

The output value of function T or of function block 1110, formed in the nth working cycle based on input data M_{0,n}, M_{1,n}, M_{9,n}, M_{14,n}, is designated Tn (cf. also FIGS. 5a through 5c). Output value Tₙ of the nth working cycle is then assigned for example to data block M_{15,n+1} of the following work cycle n+1.

Advantageously, the connection of components 1114, M₁₅E of the specific embodiment according to FIG. 6 also enables a fixed wiring, so that here as well no expensive multiplexers, etc., are required, so that as a result the number of gates for the implementation of device 1100 is very low.

Also shown in FIG. 6 is a second function unit 1120 provided for the implementation of function G according to the present invention. Function unit 1120 receives at its input (not shown in more detail in FIG. 6) the input data required for the evaluation of function G, in particular the contents of working data blocks W₀, W₁, W₂, W₄, W₅, W₆, W₇, and of input data block M₀, and the constant Kₙ, which if warranted is a function of the working cycle, which is not provided by shift registers SR_W or SR_M, but rather is provided through a separate data source (not shown; e.g., ROM, another register (RAM), etc.).

As a function of these input data, second function unit 1120 evaluates second function G according to the present invention and outputs, at output 1124, a corresponding output value (Gₙ for working cycle n) of function G. In a particularly preferred specific embodiment, this output value is supplied directly to the data block of second shift register SR_W, which corresponds to first working data block W₀. For this purpose, preferably a direct data connection is provided between output 1124 of second function unit 1120 and input W₀E of the relevant data block W₀ of second shift register SR_W, which can be fashioned for example in the form of a 32-bit-wide parallel data bus.

A third function unit 1130 is also shown in FIG. 6. Third function unit 1130 is used for the evaluation of function F according to the present invention as a function of input data W₃, T0 supplied to it; cf. the definition described above. At its output 1134, third function unit 1130 outputs an output value corresponding to function F that is assigned to working data block W₄ of second shift register SR_W. For this purpose, preferably a direct data connection is provided between output 1134 of third function unit 1130 and input W₄E of the relevant data block W₄ of second shift register SR_W, which can be fashioned for example in the form of a 32-bit-wide parallel data bus. It is to be noted that for the evaluation of functions G, F according to the present invention calculated value T0 according to Equation 3 need be evaluated only once per working cycle n. A functional integration of the two function units 1120, 1130 (and/or with component 1110) with one another is correspondingly also possible in a specific embodiment.

The structure shown in FIG. 6 advantageously enables the realization of the method described above with reference to FIG. 2b, the assignment operations prescribed according to the present invention advantageously being realized by virtue of shift registers SR_M, SR_W.

In a particularly preferred specific embodiment, in a first step input data blocks M₀ through M₁₅ (FIG. 4) are initialized with message MSG, or digital input data M, which form at least a part of message MSG (FIG. 3); cf. also step 200 from FIG. 2a. According to a specific embodiment, working data blocks W₀ through W₇ are preferably initialized using the following assignments:

W_{0,0}=0×6a09e667, W_{1,0}=0×bb67ae85, W_{2,0}=0×3c6ef372, W_{3,0}=0×a54f53a, W_{4,0}=0×510e527f, W_{5,0}=0×9b05688c, W_{6,0}=0×1f83d9ab, W_{7,0}=0×5be0cd19;

cf. step 210 from FIG. 2a.

In a particularly preferred specific embodiment, hash data blocks H₀ through H₇ (FIG. 6) are also initialized with the above-named values:

H_{0,0}=0×6a09e667, H_{1,0}=0×bb67ae85, H_{2,0}=0×3c6ef372, H_{3,0}=0×a54ff53a, H_{4,0}=0×510e527f, H_{5,0}=0×9b05688c, H_{6,0}=0×1f83d9ab, H_{7,0}=0×5be0cd19.

In a preferred specific embodiment, device 1100 also has, besides the components described above with reference to FIG. 6, an adder 1200 that receives as input quantities the content of working data block W₇ and the content of hash data block H₇. Adder 1200 correspondingly carries out a 32-bit addition (for m=1; for m=2 adder 1200 can be fashioned as a 64-bit adder), and outputs at its output 1204 a corresponding sum value that is assigned to hash data block H₀. In terms of circuitry, this can for example take place through a direct data connection between output 1204 and input H₀E of hash data block H₀, for example in the form of a 32-bit (m=1) data bus, so that here as well expensive multiplexers are not required for the address or data selection, as is the case for conventional hash devices.

In order to generate a hash value as a function of digital input data written to input data blocks M₀ through M₁₅ in the context of the initialization process, according to a particularly preferred specific embodiment the method described in the following is carried out.

Beginning from the initialization state (working cycle n=0, working data blocks and hash data blocks initialized as above with non-disappearing values, in the present case indicated as hexadecimal numbers), there takes place a modification of input data blocks M₀ through M₁₅, in the present case implemented using shift register SR_M, or its controlling or clocking, according to the method sequence according to FIG. 2b.

Analogously to this, working data blocks W₀ through W₇ are also modified according to the method sequence from FIG. 2b.

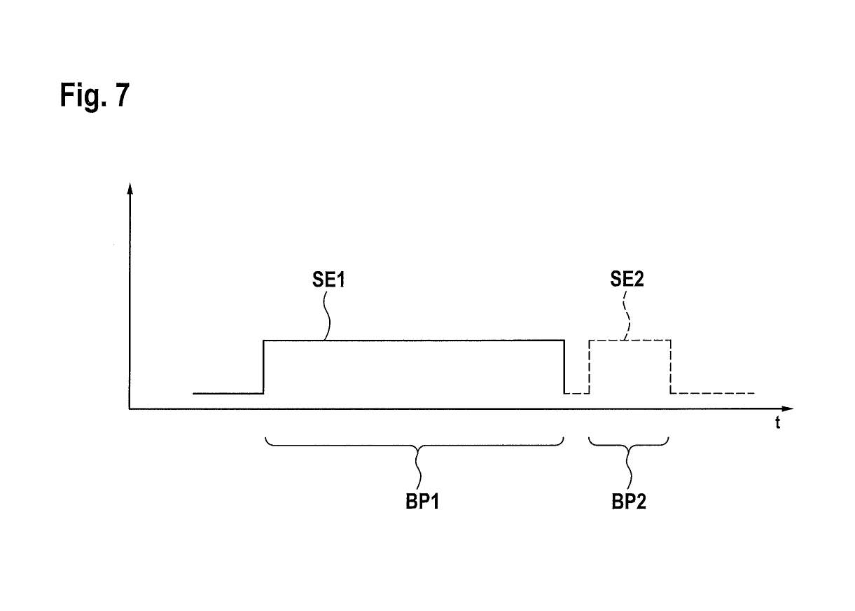

In a particularly preferred specific embodiment, the sequence according to steps 222a, 222b, 224, 226, 228 from FIG. 2b is repeated N=64 times. In this way, a first operational phase BP1 of device 1100 according to FIG. 6 is defined. This first operating phase is shown schematically in the time diagram of FIG. 7. During first operating phase BP1, the two shift registers SR_M, SR_W are accordingly clocked in such a way that from a working cycle n to the following working cycle n+1, n=0, . . . , 63, in each case they realize the assignments according to the present invention from method steps 222a, 222b (FIG. 2b). Likewise, in each working cycle the functions T, G, F are evaluated by function blocks 1110, 1120, 1130 (FIG. 6) (steps 224, 226, 228 according to FIG. 2b), whereby corresponding functional values Tₙ, Gₙ, Fₙ are obtained for the relevant nth working cycle.

After the 64^{th} execution of the method sequence according to FIG. 2b (corresponding to n=63), second shift register SR_W contains in its working data blocks W₀ through W₇ data W_{0,63}, . . . , W_{7,63}, which are already advantageously usable as hash value HW (FIG. 3). If message MSG has a length of exactly 512 bits, therefore corresponding to data M of overall message MSG, the example method according to the present invention can be terminated at this point and the content of second shift register SR_W can be used as hash value HW.

If, however, message MSG forming the basis of the hash value formation (FIG. 3) has a length greater than 512 bits, then after the carrying out 64 times of the method sequence according to FIG. 2b a second operating phase BP2 (FIG. 7) is then introduced that is used to add the current content of second shift register SR_W (FIG. 6) to the current content of third shift register SR_H. This can be considered to be an addition of two digital values each having a width of 256 bits (for m=1; for m=2 this is a 512-bit addition). In contrast to a true 256-bit addition (or 512-bit addition for m=2), in a specific embodiment the addition however preferably takes place in block-by-block fashion per 32-bit block (m=1) or per 64-bit block (m=2), preferably without carrying between adjacent blocks. To this extent, there is a difference from the addition of true 256-bit-wide data words. Because, in a preferred specific embodiment, in the preceding 64 working cycles (n=0, . . . , 63) third shift register SR_H was not already clocked, the initialization values continue to be situated in hash data blocks H₀ through H₇. Correspondingly, from the addition according to the present invention of the content of second shift register SR_W to the content of third shift register SR_H there results an addition of the “temporary hash value,” as is present in second shift register SR_W after the 64^{th} working cycle, to the initialization values of third shift register SR_H.

In a particularly preferred specific embodiment, the addition of the content of second shift register SR_W to the content of third shift register SR_H takes place using adder 1200 and a clocking eight times of shift register SR_W, SR_H, by which second operating phase BP2 (FIG. 7) is defined.

During this second operating phase BP2, there does not take place a clocking of first shift register SR_M, thus reducing the electrical consumption of energy. In a specific embodiment, the clocking of the shift registers can take place in such a way that in the first operating phase a first shift enable signal SE1 is supplied to shift registers SR_M, SR_W, causing a synchronous clocking of these shift registers SR_M, SR_W, and that in the second operating phase a second shift enable signal SE2 is supplied to shift registers SR_W, SR_H, causing a synchronous clocking of these shift registers SR_W, SR_H.

In the following, the addition of the content of second shift register SR_W to the content of third shift register SR_H is described in more detail.

At the beginning of second operating phase BP2 (FIG. 7), the contents of working data block W₇ and of hash data block H₇ are supplied to adder 1200, which carries out a 32-bit addition and outputs the corresponding sum value at its output 1204. This sum value is assigned to hash data block H₀ for the next of the total of eight working cycles used for the addition. Further hash data blocks H₁ through H₇ receive their new content for the following working cycle through shifting of hash data blocks H₀ through H₆. This means that after the first execution of a cycle of second operating phase BP2, hash block H₇ has the content of hash data block H₆ from the preceding cycle, and hash data block H₆ has the content of the hash data block from the preceding cycle, and so forth. As a result, after the first processing of a cycle of the adding process of registers SR_W, SR_H, hash data block H₀ accordingly has the sum value formed from the contents of data blocks W₇, H₇ of the preceding cycle, and further hash data blocks H₁ through H₇ contain the earlier values of hash data blocks H₀ through H₆ from the preceding cycle.

This process, which for example can also include a synchronous clocking of shift registers SR_W, SR_H, is repeated a total of eight times, so that effectively a “256-bit addition” has taken place of the contents of shift registers SR_W, SR_H, whose result is now present in third shift register SR_H in the form of hash data blocks H₀ through H₇. In contrast to a true 256-bit addition (or 512-bit addition for m=2), in a specific embodiment the addition however preferably takes place in block-by-block fashion per 32-bit block (m=1) or per 64-bit block (m=2), preferably without carrying between adjacent blocks. To this extent, there exists a difference from the addition of true, 256-bit-wide data words.

At the end of second operating phase BP2 (FIG. 7), the content of second shift register SR_W is not changed in comparison to the beginning of second operating phase BP2, because second shift register SR_W has a total of eight 32-bit-wide data blocks, and a shifting carried out eight times again leads to the initial state of second shift register SR_W at the beginning of second operating phase BP2.

If a further time index ν is introduced for second operating phase BP2 that is different from the time index, or working cycle index, n of the first operating phase, then the presently described addition of the contents of shift registers SR_W, SR_H in second operating phase BP2 can be indicated by the following rules.

At the beginning of second operating phase BP2, which corresponds to the end of the first operating phase, the index indicating the working cycle of the input data register has the value n=63. At the same time, time index ν is initialized for second operating phase BP2: ν=0. In working data blocks W₀ through W₇, data W_{0,n=63}, . . . , W_{7,n=63} are present, also designated in the following as W_{0,ν=0}, . . . , W_{7, ν=0}. Likewise, hash data blocks H₀ through H₇ are in the following also designated H_{0,ν}, . . . , H_{7, ν}.

During second operating phase BP2, time index ν is incremented up to its maximum value of ν=7, thus defining eight addition cycles. In each addition cycle, the following assignments take place:

H_{0, ν+1}=W_{7,ν}+H_{7,ν}

H_{k, ν+1}=Hₖ₋₁, ν for k=1, . . . , 7

FIG. 2c illustrates the above-described addition process 229. In step 229a, the assignment H_{0,ν+1}=W_{7, ν}+H_{7, ν} takes place, and in step 229b the assignment H_{k, ν+1}=Hₖ₋₁, ν for k=1, . . . , 7 takes place.

First, according to a specific embodiment, in first operating phase BP1 shift registers SR_M, SR_W are thus clocked N=64 times in order to form at least temporary hash values in working data blocks W, and subsequently in second operating phase BP2 shift registers SR_W, SR_H are clocked eight times in order to carry out the addition of the at least temporary hash values from the working data blocks to the values of the hash data blocks. Thus, up to this point a total of 64+8=72 working or clock cycles of device 1100 are required.

After the above-described addition of the content of second shift register SR_W to third shift register SR_H, in a preferred specific embodiment there advantageously takes place a renewed initialization of input data blocks M₀ through M₁₅, in which a next data block, including 512 bits length of message MSG, is written to first shift register SR_M. Subsequently, the two shift registers SR_M, SR_W are in turn operated for 64 clock pulses (n=64 to n=127) in the manner described above (cf. for example FIG. 2b), functions T, G, F being evaluated, so that at n=127 a temporary hash value in turn results in second shift register SR_W. Subsequently, the content of second shift register SR_W can again be added to the content of third shift register SR_H (e.g. by clocking the second and third shift registers according to ν=8 to ν=15), which corresponds to a supplementation of the hash value present as ν=7 in third shift register SR_H by hash components that are a function of the second set of input data M (e.g. bits 512 through 1023 of message MSG, if bits 0 through 511 of message MSG were processed previously, i.e., for n=0 through n=63). This process is repeated until all bits of message MSG (FIG. 3) forming the basis of the hash formation have been processed. If the overall length of message MSG, in the case of a specific embodiment with m=1, is not a whole-number multiple of 512 bits, message MSG can be brought, e.g. by padding etc., to a corresponding overall length of e*512 bits, e=1, 2, 3 . . . . If the overall length of message MSG in the case of a specific embodiment with m=2 is not a whole-number multiple of 1024 bits, message MSG can be brought, for example by padding etc., to a corresponding overall length of e*1024 bits, e=1, 2, 3 . . . .

Details concerning the division of a message MSG having more than 512 bits (for m=1) (and having more than 1024 bits for m=2), and its decomposition into 512-bit blocks (1024-bit blocks), or concerning a padding, can be learned for example from standard document FIPS180-2, described above.

If the values proposed according to a specific embodiment are used for the initialization of working data blocks W and hash data blocks H, the values also being the basis of standard document FIPS180-2, then the example method according to the present invention, using the implementation according to FIG. 6 and the value m=1, yields output values identical to those of the standardized method, and is therefore completely compatible with the FHA 256 standard.

The above-indicated initialization values can for example also be found in the document “FIPS PUB 180-4 FEDERAL INFORMATION PROCESSING STANDARDS PUBLICATION Secure Hash Standard (SHS) CATEGORY: COMPUTER SECURITY SUBCATEGORY: CRYPTOGRAPHY Information Technology Laboratory National Institute of Standards and Technology Gaithersburg, Md. 20899-8900 March 2012,” and for the initialization of the working data blocks and/or hash data blocks according to chapter 5.3.3 of the document, and for the initialization of constants Kn from Equation 3 of the present application according to chapter 4.2.2 of the document, namely for K₀ , . . . , K₆₃ these are the values 0×428a2f98, 0×71374491, 0×b5c0fbcf, 0×e9b5dba5, 0×3956c25b, 0×59f111f1, 0×923f82a4, 0×ab1c5ed5, 0×d807aa98, 0×12835b01, 0×243185be, 0×550c7dc3, 0×72be5d74, 0×80deb1fe, 0×9bdc06a7, 0×c19bf174, 0×e49b69c1, 0×efbe4786, 0×0fc19dc6, 0×240ca1cc, 0×2de92c6f, 0×4a7484aa, 0×5cb0a9dc, 0×76f988da, 0×983e5152, 0×a831c66d, 0×b00327c8, 0×bf597fc7, 0×c6e00bf3, 0×d5a79147, 0×06ca6351, 0×14292967, 0×27b70a85, 0×2e1b2138, 0×4d2c6dfc, 0×53380d13, 0×650a7354, 0×766a0abb, 0×81c2c92e, 0×92722c85, 0×a2bfe8a1, 0×a81a664b, 0×c24b8b70, 0×c76c51a3, 0×d192e819, 0×d6990624, 0×f40e3585, 0×106aa070, 0×19a4c116, 0×1e376c08, 0×2748774c, 0×34b0bcb5, 0×391c0cb3, 0×4ed8aa4a, 0×5b9cca4f, 0×682e6ff3, 0×748f82ee, 0×78a5636f, 0×84c87814, 0×8cc70208, 0×90befffa, 0×a4506ceb, 0×bef9a3f7, 0×c67178f2, i.e. for example K₀=0×428a2f98, K₇=0×ab1c5ed5, K₈=0×d807aa98. These values for Kn also hold for SHA224; however, for SHA224 other values are to be selected for the initialization of the working data blocks and/or hash data blocks than for SHA256.

If, for the initialization of the working data block W and hash data blocks H, the values proposed according to a further specific embodiment are used, also forming the basis of standard document FIPS180-2, then the method according to the present invention, using the implementation according to FIG. 6 and the value m=2, yields output values identical to those of the standardized method, and is therefore completely compatible with the SHA 512 standard. The above-indicated initialization values can for example also be found in the document “FIPS PUB 180-4 FEDERAL INFORMATION PROCESSING STANDARDS PUBLICATION Secure Hash Standard (SHS) CATEGORY: COMPUTER SECURITY SUBCATEGORY: CRYPTOGRAPHY Information Technology Laboratory National Institute of Standards and Technology Gaithersburg, Md. 20899-8900 March 2012,” and for the initialization of the working data blocks and/or hash data blocks according to chapter 5.3.5 of the document, and for the initialization of constants Kn from Equation 3 of the present application according to chapter 4.2.3 of the document, namely for K₀, . . . , K₆₃ these are the values 0×428a2f98d728ae22, 0×7137449123ef65cd, 0×b5c0fbcfec4d3b2f, 0×e9b5dba58189dbbc, 0×3956c25bf348b538, 0×59f111f1b605d019, 0×923f82a4af14f9b, 0×ab1c5ed5da6d8118, 0×d807aa98a3030242, 0×12835b0145706fbe, 0×243185be4ee4b28c, 0×550c7dc3d5ffb4e2, 0×721be5d74f2719396f, 0×80deb1fP3b16961b1, 0×9bdc06a725c71235, 0×c19bf174cf692694, 0×e49b69c19ef14ad2, 0×efbe4786334f25e3, 0×fc19dc63b3cd5b5, 0×x240ca1cc77ac9c65, 0×2de92c6f592190275, 0×4a7484aa6ea6e483, 0×5cb0a9dcbd41fbd4, 0×76f983da8311531b5, 0×983e5159ee66dfab, 0×a81c66d2d1943210, 0×1b00327c898f19213f, 0×bf597fc7beef0ee4, 0×06e001bf33da83f02, 0×d5a79147930aa725, 0×06ca6351e003326f, 0×142929670a0e6e70, 0×27b70a8546d22ffc, 0×2e1b21385c26c926, 0×4d2c6dfc5ac42aed, 0×53380d139d95193df, 0×650a73548baf63de, 0×766a0abb3c77b2a8, 0×81c2c92e47edaee6, 0×92722c851482353b, 0×a2bfe8a14cf10364, 0×xa81a664bbc423001, 0×c24b8b70d0f89791, 0×c76c51a30654be30, 0×d192e819d6ef5218, 0×d69906245565a910, 0×f40e35855771202a, 0×106aa07032bbd1b8, 0×19a4c116b8d2d0c8, 0×1e376c085141ab53, 0×2748774cdf8eeb99, 0×34b0bcb5e19b48a8, 0×391c0cb3c5c95a63, 0×4ed8aa4ae3418acb, 0×5b9cca4f7763e373, 0×682e6ff3d6b2b8a3, 0×748f82ee5defb2fc, 0×78a5636f43172f60, 0×84c87814a1f0ab72, 0×8cc702081a6439ec, 0×90befffa23631e28, 0×a4506cebde82bde9, 0×bef9a3f7b2c67915, 0×c67178f2e372532b, 0×ca273eceea26619c, 0×d186b8c721c0c207, 0×eada7dd6cde0eble, 0×f57d4f7fee6ed178, 0×06f067aa72176fba, 0×0a637dc5a2c898a6, 0×113f9804bef90dae, 0×1b710b35131c471b, 0×28db77f523047d84, 0×32caab7b40c72493, 0×4cc5d4becb3e42b6, 0×431d67c49c100d4c, 0×4cc5d4becb3e42b6, 0×597f299cfc657e2a, 0×5fcb6fab3ad6faec, 0×6c44198c4a475817; i,e, for example K₀=0×428a2f98d728ae22, K₇=0×ab1c5ed5da6d8118, K₈=d807aa98a3030242.

These values for Kn also hold for SHA384; however, for SHA384 other values are to be selected for the initialization of the working data blocks and/or hash data blocks than for SHA512.

Differing from conventional SHA-2 implementations, device 1100 according to the example embodiment of the present invention however uses a less complex design, which is reflected in particular in a substantial reduction of the number of required gate equivalents for the implementation of device 1100 according to the present invention. In particular, the example implementation according to FIG. 6 according to the present invention requires a significantly lower number of multiplexers, which is a result of the structure according to the present invention of functions T, G, F and their “data connection” to the described data blocks M, W.

In a further preferred specific embodiment, the value 2 is chosen for the parameter m. In this case, input data blocks M₀ through M₁₅, working data blocks W₀ through W₇, and, if warranted, hash data blocks H₀ through H₇ each have a data width of 64 bits. The same preferably holds for data buses that may be present between the relevant data blocks, or registers containing them. The number of data blocks itself does not change. To this extent, the structure shown in FIG. 6 can also be used to generate hash values of the type SHA 512.

Differing from the above under described specific embodiment, which relates to the 32-bit implementation with m=1, for a 64-bit implementation (m=2) the following definitions are to be selected for the functions T, G, F:

T=M_{0,n}+M_{9,n} +(ROTR¹⁹ (M_{14,n}) XOR ROTR⁶¹ (M_{14,n}) XOR SHR⁶(M_{14,n}))+(ROTR¹ (M_{1,n}) XOR ROTR⁸(M_{1,n}) XOR SHR⁷ (M_{1,n})),

G=T0+T1,

where

T0=M_{0,n}+W_{7,n}+(ROTR¹⁴(W_{4,n}) XOR ROTR¹⁸(W_{4,n}) XOR ROTR⁴¹ (W_{4,n}))+((W_{4,n} AND W_{5,n}) XOR (NOT (W_{4,n}) AND W_{6,n}))+Kn,

where T1 =(ROTR²⁸(W_{0,n}) XOR ROTR³⁴(W_{0,n}) XOR ROTR″(W_{0,n}))+((W_{0,n} AND W_{1,n}) XOR (W_{0,n} AND W_{2,n}) XOR (W_{1,n} AND W_{2,n})), where

F=W_{3,n}+T0.

Given the selection of the parameter m=2, N=80 and the initialization values for working data blocks W₀ through W₇ and hash data blocks H₀ through H₇ according to the following equations, it is advantageously ensured that the method according to the present invention is completely compatible, with regard to the obtained hash values, with the SHA-2 standard of type SHA512.

W_{0,0}=0×6a09e667f3bcc908, W_{1,0}=0×bb67ae8584caa73b, W_{2,0}=0×3c6ef372fe94f82b, W_{3,0}=0×a54ff53a5f1d36f1, W_{4,0}=0×510e527fade682d1, W_{5,0}=0×9b05688c2b3e6c1f, W_{6,0}=0×1f83d9abfb41bd6b, W_{7,0}=0×5be0cd19137e2179,

H_{0,0}=0×6a09e667f3bcc908, H_{1,0}=0×bb67ae8584caa73b, H_{2,0}=0×3c6ef372fe94f82b, H_{3,0}=0×a54ff53a5f1d36f1, H_{4,0}=0×510e527fade682d1, H_{5,0}=0×9b05688c2b3e6c1f, H_{6,0}=0×1f83d9abfb41bd6b, H_{7,0}=0×5be0cd19137e2179.

In further advantageous specific embodiments, initialization values can also be used that deviate from the above-proposed initialization values, and/or other values can be chosen for constants Kₙ; in this case, complete compatibility with the SHA-2 methods is then not present. However, here as well powerful implementations result for the determination of hash values with low hardware complexity.

The use of the design according to the present invention may result in a reduction of approximately 40% with regard to the required number of gate equivalents. In addition, when there is compatibility with SHA 256 only 72 working cycles are required, and when there is compatibility with SHA 512 only 88 working cycles are required.

If, instead of the “serial” addition brought about by eight clockings of shift registers SR_W, SR_H and of the 32-bit-wide, or 64-bit-wide, adder 1200 (FIG. 6) (cf. also FIG. 2c), according to a further advantageous specific embodiment a 256-bit adder (for m=1; for m=2 a 512-bit adder is required) is provided, then the addition of the working data blocks to the hash data blocks can take place in a single clock pulse, so that a complete hash value formation for m=1, given a message of 512 bits length, requires only 65 working cycles, so that eight clock pulses can be saved. In contrast to a true 256-bit addition (or 512-bit addition for m=2), in a specific embodiment the addition however preferably takes place in block-by-block fashion per 32-bit block (m=1) or per 64-bit block (m=2), preferably without carry between adjacent blocks. To this extent, there is a difference from the addition of true, 256-bit-wide data words.

In a further advantageous specific embodiment, in which message MSG forming the basis of the hash value formation is longer than 512 bits, a subsequent initialization of first shift register SR_M (for cycles n=64 through n=127) with a following block M of message MSG can take place already 16 working cycles earlier than for the above-described specific embodiment. This is possible because functions G, F proposed according to the present invention advantageously require only the content of input data block M₀, but not the content of further input data blocks. Due to the topology of the specific embodiment according to FIG. 6, the value of input data block M₀ thus required for the renewed evaluation of function F, G is thus present 16 working cycles earlier, i.e., already after the 48^{th} working cycle (i.e., at n=47) of the sequence illustrated in FIG. 2b. Using the shift register-based architecture illustrated in FIG. 6, it is thus possible to begin earlier the initialization of input data blocks M with additional parts of a message MSG forming the basis of the hash value formation. Here, an increase in performance by an additional 20% can be expected.

A further advantage of the shift register-based architecture illustrated by FIG. 6 is that input data M (FIG. 3) can be brought efficiently into the input data blocks, for example for an initialization, by an external unit (not shown; for example a microcontroller or the like), for example through serial or parallel supplying of the input data e.g. to input data block M₁₅. As soon as (for m=1) for example the first 32 bits of the input data have been carried into input data block M₁₅, first shift register SR M can be clocked once in order to shift the content from input data block M₁₅ to input data block M₁₄, etc. Therefore, the external unit that provides input data M requires only one data connection (interface) to input data block M₁₅. Particularly advantageously, for this purpose for example the already-present input M₁₅E can be used, which in the subsequent hash value formation receives output values Tn of function T from first function block 1110.

In a further advantageous case of application, in which the length of message MSG forming the basis of the hash value formation is exactly 512 bits, the sum formation (cf. e.g. step 229 from FIG. 2b) can be reduced by a few working cycles with regard to shift registers SR_W, SR_H, because the contents of working data blocks W₅, W₆, W are merely shifted copies of working data block W₄. Here, potentially a further four working cycles can be saved, resulting in an increase in performance of about 5%. In itself, at this message length, as already described, no sum formation at all is required; rather, the content of the working data blocks, or of second shift register SR_W, can be used directly as hash value HW of 512-bit message MSG, M. The above-named sum formation is required only when compatibility with SHA 256 is desired.

The design according to the present invention can be realized in the form of an ASIC and/or FPGA and/or microcontroller and/or DSP (digital signal processor, or through direct implementation in circuitry, resulting in the particular advantages of low complexity and efficient hash value formation. According to investigations carried out by applicant, the design according to the present invention can be realized for example in a standard CMOS process, using a maximum of approximately 12,000 gates or gate equivalents. For example, device 1100 according to FIG. 6 can be implemented as an integrated circuit using standard semiconductor processes (e.g. CMOS technology).

In a further particularly preferred specific embodiment, the round constants Kn can also be stored in an SRAM (static random access memory), further significantly reducing the complexity of the implementation in circuitry. This is recommended in particular in the case of an at least partial implementation of the present invention in an FPGA.

The design according to the present invention can for example also be realized in the form of VHDL code; here planned electronic circuits can be expanded by the functionality according to the present invention through supplementation corresponding VHDL codes.

What is claimed is:

1. A method for generating a hash value as a function of digital input data, the method comprising:
a) dividing the digital input data into 16 input data blocks each having length 32*m bits, m being a whole number greater than or equal to one, and an index variable i=0, . . . , 15 designating an ith input data block Mᵢ;
b) initializing eight working data blocks having specifiable values, each of the eight working data blocks having a length of 32*m bits, and an index variable k=0, . . . , 7 designating a kth working data block Wₖ; and
c) modifying the input data blocks and the working data blocks according to the following:
c1) assigning content of input data block Mᵢ,ₙ to input data block M_{i-1, n+1} for i=1 through 15, where n is a whole number greater than or equal to zero and represents a processing cycle,
c2) assigning content of working data block W_{k,n} to working data block W_{k+1, n+1} for k=0, k=1, k=2, and for k=4, k=5, k=6,
c3) assigning an output value of a first function T to input data block M_{15, n+1},
c4) assigning an output value of a second function G to working data block W_{0, n+1},
c5) assigning an output value of a third function F to working data block W_{4, n+1};
wherein step c) is carried out N times, where N>1.

2. The method as recited in claim 1, wherein in the case where m=1:
the function T is defined as T=M_{0,n}+M_{9,n}+(ROTR¹⁷ (M_{14,n}) XOR ROTR¹⁹(M_{14,n}) XOR SHR¹⁰ (M_{14,n}))+(ROTR⁷(M_{1,n}) XOR ROTR¹⁸ (M_{1,n}) XOR SHR³(M_{1,n})), ROTR^{y} (x) being a bitwise rotation of the operand x by y bits to the right, SHR^{y}(x) being a bitwise logical shift of the operand x by y bits to the right, XOR being an exclusive OR operation, the function G is defined as G=T0+T1, where T0=M_{0,n}+W_{7,n}+(ROTR⁶(W_{4,n}) XOR ROTR¹¹(W_{4,n}) XOR ROTR²⁵(W_{4,n}))+((W_{4,n} AND W_{5,n}) XOR (NOT(W_{4,n}) AND W_{6,n}))+Kₙ, where T1=(ROTR²(W_{0,n}) XOR ROTR¹³ (W_{0,n}) XOR ROTR²²(W_{0,n}))+((W_{0,n} AND W_{1,n}) XOR (W_{0,n} AND W_{2,n}) XOR (W_{1,n} AND W_{2,n})), AND being an AND operation, NOT being a bitwise negation, W_{k,n} being the kth working data block of the processing cycle n, Kₙ being a specifiable constant, and the function F is defined as F=W_{3,n}+T0, and
wherein in the case where m=2:
the function T is defined as T=M_{0,n}+M_{9,n}+(ROTR¹⁹ (M_{14,n}) XOR ROTR⁶¹(M_{14,n}) XOR SHR⁶(M_{14,n}))+(ROTR¹(M_{1,n}) XOR ROTR⁸(M_{1,n}) XOR SHR⁷(M_{1,n})), the function G is defined as G=T0+T1, where T0=M_{0,n}+W_{7,n}+(ROTR¹⁴ (W_{4,n}) XOR ROTR¹⁸(W_{4,n}) XOR ROTR⁴¹(W_{4,n}))+((W_{4,n} AND W_{5,n}) XOR (NOT(W_{4,n}) AND W_{6,n}))+Kₙ, where T1=(ROTR²⁸(W_{0,n}) XOR ROTR²⁴ (W_{0,n}) XOR ROTR³⁹(W_{0,n}))+((W_{0,n} AND W_{1,n}) XOR (W_{0,n} AND W_{2,n}) XOR (W_{1,n} AND W_{2,n})), and the function F is defined as F=W_{3,n}+T0.

3. The method as recited in claim 1, eight hash data blocks being provided, each of the eight hash data blocks having a length of 32*m bits, and after execution (r*N) times of step c) the content of the working data blocks being added blockwise, to the content of the hash data blocks, r being a whole number greater than or equal to 1.

4. The method as recited in claim 3, wherein adding includes:
d1) assigning a sum of working data block W_{7,n} and hash data block H_{7,n} to hash data block H_{0,n+1},
d2) assignment of the value of hash data block H_{I-1,n} to hash data block H_{I,n+1} for I=1 through 7.

5. The method as recited in claim 1, wherein at least one of: i) m=1, ii) N=64, iii) in the initializing of the eight working data blocks the following assignment takes place: W_{0,0}=0×6a09e667, W_{1,0}=0×bb67ae85, W_{2,0}=0×3c6ef372, W_{3,0}=0×a54ff53a, W_{4,0}=0×510e527f, W_{5,0}=0×9b05688c, W_{6,0}=0×1f83d9ab, W_{7,0}=0×5be0cd19, and iv) the eight hash data blocks are initialized using the following assignment: H_{0,0}=0×6a09e667, H_{1,0}=0×bb67ae85, H_{2,0}=0×3c6ef372, H_{3,0}=0×a54ff53a, H_{4,0}=0×510e527f, H_{5,0}=0×9b05688c, H_{6,0}=0×1f83d9ab, H_{7,0}=0×5be0cd19.

6. The method as recited in claim 4, wherein at least one of: i) m=2, ii) N=80, iii) in the initializing of the eight working data blocks, the following assignment takes place: W_{0,0}=0×6a09e667f3bcc908, W_{1,0}=0×bb67ae8584caa73b, W_{2,0}=0×3c6ef372fe94f82b, W_{3,0}=0×a54ff53a5f1d36f1, W_{4,0}=0×510e527fade682d1, W_{5,0}=0×9b05688c2b3e6c1f, W_{6,0}=0×1f83d9abfb41bd6b, W_{7,0}=0×5be0cd19137e2179, and iv) the eight hash data blocks are initialized using the following assignment: H_{0,0}=0×6a09e667f3bcc908, H_{1,0}=0×bb67ae8584caa73b, H_{2,0}=0×3c6ef372fe94f82b, H_{3,0}=0×a54ff53a5f1d36f1, H_{4,0}=0×510e527fade682d1, H_{5,0}=0×9b05688c2b3e6c1f, H_{6,0}=0×1f83d9abfb41bd6b, H_{7,0}=0×5be0cd19137e2179.

7. The method as recited in claim 1, further comprising at least one of:
i) using a first shift register for at least temporary storage of the input data blocks;
ii) using a second shift register for at least temporary storage of the working data blocks;
ii) using a third shift register for at least temporary storage of the hash data blocks.

8. The method as recited in claim 7, wherein at least one of: i) the assigning of the content of input data block M_{i,n} to input data block M_{i-1,n+1} for i=1 through 15 includes a blockwise shifting of the content of input data block M_{i,n} to the first shift register, ii) in the assigning of the content of working data block W_{k,n} to working data block W_{k+1,n+1} for k=0, k=1, k=2 and for k=4, k=5, k=6 includes a blockwise shifting of the content of working data block W_{k,n} to the second shift register, and iii) the assigning of the value of hash data block H_{I-1,n} to hash data block H_{I,n+1} for I=1 through 7 includes a blockwise shifting of the content of hash data block H_{I-1,n} to the third shift register.

9. The method as recited in claim 8, wherein the first shift register and the second shift register are clocked together, in a first operating phase, for N clock cycles to control the blockwise shifting of the content of the first shift register and the blockwise shifting of the content of the second shift register, and, in a second operating phase that follows the first operating phase, the second shift register and the third shift register are clocked together for eight clock cycles, no clocking of the first shift register taking place during the second operating phase.

10. The method as recited in claim 8, wherein in a first operating phase, no clocking of the third shift register takes place.

11. The method as recited in claim 9, wherein at least one of:
i. the following steps being executed in order to determine the expressions ROTR¹⁷(M_{14,n}) ROTR¹⁹(M_{14,n}) of the first function T:
e1) determining expression V1=ROTR¹⁷ (M_{14,n}) and
e2) determining expression V2=ROTR² (V1 to obtain ROTR¹⁹ (M_{14,n}) ;
ii. the following steps being executed in order to determine the expressions ROTR⁷(M_{1,n}), ROTR¹⁸(M_{1,n}) of the first function T:
f1) determining expression V3=ROTR⁷(M_{1,n}),
f2) determining expression V4=ROTR¹¹ (V3), in order to obtain ROTR¹⁸(M_{1,n}); and
iii. the following steps being executed in order to determine the expressions ROTR² (W_{0,n}), ROTR¹³(W_{0,n}), ROTR²²(W_{0,n}) of the second function G:
g1) determining expression V5=ROTR² (W_{0,n}),
g2) determining expression V6=ROTR¹¹ (V5 to obtain ROTR¹³ (W0,n),
g3) determining expression V7=ROTR⁹ (V6 to obtain ROTR²² (W0,n).

12. A device for generating a hash value as a function of digital input data, the device configured to: a) divide the input data into 16 input data blocks each having length 32*m bits, m being a whole number greater than or equal to one, and an index variable i=0, . . . , 15 designating the ith input data block Mᵢ, b) initialize eight working data blocks having specifiable values, each of the eight working data blocks having a length of 32*m bits, and an index variable k=0, . . . , 7 designating the kth working data block Wₖ, c) modify the input data blocks and the working data blocks according to the following rules:
c1) assign content of input data block M_{i,n} to input data block M_{i-1, n+1} for i=1 through 15, where n is a whole number greater than or equal to zero and represents a processing cycle,
c2) assign content of working data block W_{k,n} to working data block W_{k+1, n+1} for k=0, k=1, k=2, and for k=4, k=5, k=6,
c3) assignment of an output value of a first function T to input data block M_{15, n+1},
c4) assign an output value of a second function G to working data block W_{0, n+1};
c5) assign an output value of a third function F to working data block W_{4, n+1}, the device being fashioned to carry out step c) of the modification (220) N times, where N>1.

13. The device as recited in claim 12, wherein in the case where m=1:
the function T is defined as T=M_{0,n}+M_{9,n}+(ROTR¹⁷ (M_{14,n}) XOR ROTR¹⁹ (M_{14,n}) XOR SHR¹⁰ (M_{14,n}))+(ROTR⁷(M_{1,n}) XOR ROTR¹⁸(M_{1,n}) XOR SHR³(M_{1,n})), ROTR^{y} (x) being a bitwise rotation of the operand x by y bits to the right, SHR^{y} (x) being a bitwise logical shift of the operand x by y bits to the right, XOR being an exclusive OR operation, the function G is defined as G=T0+T1, where T0=M_{0,n}+W_{7,n}+(ROTR⁶(W_{4,n}) XOR ROTR¹¹(W_{4,n}) XOR ROTR²⁵(W_{4,n}))+((W_{4,n} AND W_{5,n}) XOR (NOT(W_{4,n}) AND W_{6,n}))+Kₙ, where T1=(ROTR²(W_{0,n}) XOR ROTR¹³(W_{0,n}) XOR ROTR²² (W_{0,n}))+((W_{0,n} AND W_{1,n}) XOR (W_{0,n} AND W_{2,n}) XOR (W_{1,n} AND W_{2,n})), AND being an AND operation, NOT being a bitwise negation, W_{k,n} being the kth working data block of the processing cycle n, Kₙ being a specifiable constant, the function F is defined as F=W_{3,n}+T0, and
wherein in the case where m=2:
the function T is defined as T=M_{0,n}+M_{9,n} (ROTR¹⁹(M_{14,n}) XOR ROTR⁶¹ (M_{14,n}) XOR SHR⁶ (M_{14,n}))+(ROTR¹ (M_{1,n}) XOR ROTR⁸ (M_{1,n}) XOR SHR⁷ (M_{1,n}) the function G is defined as G=T0+T1, where T0=M_{0,n}+W_{7,n} +(ROTR¹⁴(W_{4,n}) XOR ROTR¹⁸ (W_{4,n}) XOR ROTR⁴¹(W_{4,n}))+((W_{4,n} AND W_{5,n}) XOR (NOT(W_{4,n}) AND W_{6,n}))+Kₙ, where T1=(ROTR²⁸(W_{0,n}) XOR ROTR³⁴(W_{0,n}) XOR ROTR³⁹(W_{0,n})) (W_{0,n} AND W_{1,n}) XOR (W_{0,1}, AND W_{2,n}) XOR (W_{1,n} AND W_{2,n})), and the function F is defined as F=W_{3,n}+T0.

14. The device as recited in claim 12, further comprising at least one of:
i) a first shift register to at least temporarily store of the input data blocks,
ii) a second shift register to at least temporarily store the working data blocks, and
iii) third shift register to at least temporarily store of the hash data blocks.

15. The device as recited in claim 14, further comprising at least one of:
i) a first function block to carry out the first function T,
ii) a second function block to carry out the second function G, and
iii) a third function block to carry out the third function F, wherein an output of the first function block is connected to an input assigned to input data block M₁₅, of the first shift register, an output of the second function block is connected to an input assigned to working data block W₀, of the second shift register, and an output of the third function block is connected to an input assigned to working data block W₄, of the second shift register.

16. The device as recited in claim 15, further comprising:
an adder fashioned to add a content of the working data block W₇ to a content of the hash data block H₇, an output of the adder being connected to an input, assigned to the hash data block H₀, of the third shift register.

17. The device as recited in claim 15, wherein the device is designed to, in a first operating phase, clock the first shift register and the second shift register together for N clock cycles, and, in a second operating phase that follows the first operating phase, to clock the second shift register and the third shift register together for eight clock cycles, no clocking of the first shift register taking place during the second operating phase, and no clocking of the third shift register taking place during the first operating phase.

18. The device as recited in claim 17, wherein the device is an integrated circuit using CMOS technology.
